(19) United States
(12) Patent Application Publication
(10) Pub. No.: US 2022/0284678 A1
(43) Pub. Date: Sep. 8, 2022

(54) METHOD AND APPARATUS FOR PROCESSING FACE INFORMATION AND ELECTRONIC DEVICE AND STORAGE MEDIUM

(71) Applicant: Shanghai Sense Time Intelligent Technology Co., Ltd., Shanghai (CN)

(72) Inventors: Zukai CHEN, Shanghai (CN); Shengwei XU, Shanghai (CN); Chunze LIN, Shanghai (CN); Quan WANG, Shanghai (CN); Chen QIAN, Shanghai (CN)

(21) Appl. No.: 17/825,468

(22) Filed: May 26, 2022

Related U.S. Application Data
(63) Continuation of application No. PCT/CN2021/108105, filed on Jul. 23, 2021.

(30) Foreign Application Priority Data
Nov. 25, 2020 (CN) 202011339595.5

(51) Int. Cl. G06T 17/20; G06V 40/16; G06T 7/55; G06T 7/90

(52) U.S. Cl. CPC G06T 17/20; G06V 40/174; G06T 7/55; G06V 40/168; G06T 7/90; G06T 2207/30201; G06T 2210/56; G06T 2207/10028; G06T 2207/20084; G06T 2207/10024

(57) ABSTRACT

Methods, apparatus, electronic devices, and storage mediums fir processing face information are provided. In one aspect, a method includes: obtaining a first face image and dense point cloud data respectively corresponding to multiple second face images of a preset style; based on the first face image and the dense point cloud data respectively corresponding to the multiple second face images of the preset style, determining dense point cloud data of the first face image under the preset style; and, based on the dense point cloud data of the first face image under the preset style, generating a virtual face model of the first face image under the preset style.

### CROSS REFERENCE TO RELATED APPLICATIONS

This application is a continuation application of international Application No. PCT/CN2021/108105 filed on Jul. 23, 2021, which claims priority to Chinese Patent Application No. 202011339595.5 filed on Nov. 25, 2020, the entire contents of which are incorporated herein by reference in their entireties.

### TECHNICAL FIELD

The present disclosure relates to the technical field of image processing, and in particular to a method and an apparatus for processing face information, and an electronic device and a storage medium.

### BACKGROUND

As the artificial intelligence technologies develop, image processing technologies are more and more applied to application scenarios of virtual images, for example, games, animations and social communications and the like. In different application scenarios, virtual face models of different styles such as classic style, modern style, western style and Chinese style can be constructed. Generally, it is required to set a construction manner of a virtual face model corresponding to each application style, resulting in low flexibility and low efficiency.

### SUMMARY

The embodiments of the present disclosure at least provide a solution for processing face information.

According to a first aspect of embodiments of the present disclosure, there is provided a method of processing face information, including: obtaining a first face image, and dense point cloud data respectively corresponding to multiple second face images of a preset style; based on the first face image and the dense point cloud data respectively corresponding to the multiple second face images of the preset style, determining dense point cloud data of the first face image in the preset style; based on the dense point cloud data of the first face image in the preset style, generating a virtual face model of the first face image in the preset style.

In the embodiments of the present disclosure, according to the dense point cloud data. respectively corresponding to multiple second face images for different styles, a virtual face model of the first face image under the corresponding style can be quickly determined, such that the virtual face model can be more flexibly generated so as to improve a generation efficiency of a virtual face model of a face image under a preset style.

In a possible implementation, based on the first face image and the dense point cloud data respectively corresponding to the multiple second face images of the preset style, determining the dense point cloud data of the first face image under the preset style includes: extracting face parameter values of the first face image and face parameter values respectively corresponding to the multiple second face images of the preset style; where face parameter values include parameter values representing a face shape and parameter values representing a face expression; based on the face parameter values of the first face image and the face parameter values and the dense point cloud data respectively corresponding to the multiple second face images of the preset style, determining the dense point cloud data of the first face image in the preset style.

In an embodiment of the present disclosure, the dense point cloud data of the first face image under the preset style can be determined based on the face parameter values of the first face image and multiple second face images of the preset style. Because a smaller number of parameter values are used to represent a face by using the face parameter values, the dense point cloud data of the first face image under the preset style may be determined more quickly.

In a possible implementation, based on the face parameter values of the first face image and the face parameter values and the dense point cloud data respectively corresponding to the multiple second face images of the preset style, determining the dense point cloud data of the first face image in the preset style includes: based on the face parameter values of the first face image and the face parameter values respectively corresponding to the multiple second face images of the preset style, determining linear fitting coefficients between the first face image and the multiple second face images of the preset style; based on the dense point cloud data respectively corresponding to the multiple second face images of the preset style and the linear fitting coefficients, determining the dense point cloud data of the first face image in the preset style.

In an embodiment of the present disclosure, it is proposed that linear fitting coefficients indicating an association relationship between the first face image and multiple second face images of a preset style are obtained quickly by use of a smaller number of face parameter values, and further, the dense point cloud data of the multiple second face images of the preset style may be adjusted based on the linear fitting coefficients so as to quickly obtain the dense point cloud data of the first face image under the preset style.

In a possible implementation, based on the face parameter values of the first face image and the face parameter values respectively corresponding to the multiple second face images of the preset style, determining the linear fitting coefficients between the first face image and the multiple second face images of the preset style includes: obtaining current linear fitting coefficients, where in a case that the current linear fitting coefficients are initial linear fitting coefficients, the initial linear fitting coefficients are preset; based on the current linear fitting coefficients and the face parameter values respectively corresponding to the multiple second face images of a preset style, predicting current face parameter values of the first face image; based on the predicted current face parameter values and the face parameter values of the first face image, determining a current loss value; based on the current loss value and a constraint range corresponding to the preset linear fitting coefficients, adjusting the current linear fitting coefficients to obtain adjusted linear fitting coefficients; and, by taking the adjusted linear fitting coefficients as the current linear fitting coefficients, returning to perform the step of predicting the current face parameter values, until, in a case that an operation for adjusting the current linear fitting coefficients satisfies an adjustment cutoff condition, the linear fitting coefficients are obtained based on the current linear fitting coefficients.

In an embodiment of the present disclosure, in a process of adjusting the linear fitting coefficients between the first face image and the multiple second face images of the preset style, several adjustments are performed for the linear fitting coefficients based on the loss value and/or adjustment number, so as to improve the accuracy of the linear fitting coefficients; on the other hand, during the adjustment process, adjustment constraining is performed based on the constraint range of the preset linear fitting coefficients, such that the dense point cloud data of the first face image under the preset style can be determined more reasonably based on the obtained linear fitting coefficients.

In a possible implementation, dense point cloud data includes coordinate values of multiple corresponding dense points; based on the dense point cloud data respectively corresponding to the multiple second face images of the preset style and the linear fitting coefficients, determining the dense point cloud data of the first face image in the preset style includes: based on the coordinate values of the dense points respectively corresponding to the multiple second face images of the preset style, determining coordinate values of corresponding points in average dense point cloud data; based on the coordinate values of the dense points respectively corresponding to the multiple second face images and the coordinate values of the corresponding points in the average dense point cloud data, determining coordinate difference values respectively corresponding to the multiple second face images; based on the coordinate difference values respectively corresponding to the multiple second face images and the linear fitting coefficients, determining coordinate difference values corresponding to the first face image; based on the coordinate difference values corresponding to the first face image and the coordinate values of the corresponding points in the average dense point cloud data, determining the dense point cloud data of the first face image in the preset style.

In an embodiment of the present disclosure, in a case that the second face images are fewer, dense point cloud data of different first face images under the preset style can be accurately represented by using the dense point cloud data of multiple second face images.

In a possible implementation, the method further includes: in response to a style update triggering operation, obtaining dense point cloud data respectively corresponding to multiple second face images of a changed style; based on the first face image and the dense point cloud data respectively corresponding to the multiple second face images of the changed style, determining dense point cloud data of the first face image in the changed style; based on the dense point cloud data of the first face image in the changed style, generating a virtual face model of the first face image in the changed style.

In an embodiment of the present disclosure, in response to detecting the style update triggering operation, based on the pre-stored dense point cloud data of the multiple second face images of a changed style, a virtual face model of the first face image under the changed style is obtained quickly, thus improving the efficiency of determining the virtual face models of the first face image under different styles.

In a possible implementation, the method further includes: obtaining decoration information and skin color information corresponding to the first face image; based on the decoration information, the skin color information and a generated virtual face model corresponding to the first face image, generating a virtual face image corresponding to the first face image.

In an embodiment of the present disclosure, according to the decoration information and the skin color information selected by a user, a virtual face image corresponding to the first face image can be generated, so as to improve interaction with the user and increase the user experiences.

In a possible implementation, face parameter values are extracted by a neural network pre-trained, and the neural network is obtained by training based on sample images pre-labeled with face parameter values.

In an embodiment of the present disclosure, it is proposed that extracting face parameter values of a face image by a pre-trained neural network can improve the extraction efficiency and accuracy for the face parameter values.

In a possible implementation, the neural network is pre-trained in the following manner: obtaining a sample image set, where the sample image set includes multiple sample images and labeled face parameter values corresponding to each of the multiple sample images; inputting the multiple sample images into a to-be-trained neural network to obtain predicted face parameter values corresponding to each of the multiple sample images; based on the predicted face parameter values and the labeled face parameter values corresponding to each of the multiple sample images, adjusting network parameter values of the to-be-trained neural network to obtain a trained neural network.

In an embodiment of the present disclosure, during a process of training a neural network for extracting face parameter values, it is proposed that continuous adjustments are performed for the network parameter values of the neural network based on the labeled face parameter values of each sample image so as to obtain a neural network with high accuracy.

According to a second aspect of embodiments of the present disclosure, there is provided an apparatus for processing face information, including: an obtaining module, configured to obtain a first face image, and dense point cloud data respectively corresponding to multiple second face images of a preset style; a determining module, configured to, based on the first face and the dense point cloud data respectively corresponding to the multiple second face images of the preset style, determine dense point cloud data of the first face image in the preset style; a generating module, configured to, based on the dense point cloud data of the first face image in the preset style, generate a virtual face model of the first face image in the preset style.

According to a third aspect of embodiments of the present disclosure, there is provided an electronic device, including a processor, a memory and a bus, where the memory stores machine readable instructions executable by the processor, and when the electronic device runs, the processor communicates with the memory via the bus, and the machine readable instructions are executed by the processor to implement the steps of the method as mentioned in the first aspect.

According to a fourth aspect of embodiments of the present disclosure, there is provided a computer readable storage medium, storing computer programs, where the computer programs are executed by a processor to implement the steps of the method as mentioned in the first aspect.

In order to make the above objects, features and advantages of the present disclosure clearer and more understandable, detailed descriptions will be made below to preferred embodiments in combination with the accompanying drawings.

### BRIEF DESCRIPTION OF THE DRAWINGS

In order to more clearly describe the technical solutions of the embodiments of the present disclosure, accompanying drawings required for description of the embodiments will be briefly introduced. These drawings show the embodiments of the present disclosure and serve to explain the technical solutions of the present disclosure together with the specification. It should be understood that the following drawings only show some embodiments of the present disclosure and thus shall not be considered as limiting of the scope of the present disclosure. Those skilled in the art may also obtain other relevant drawings based on these drawings without making creative work.

FIG. 1 is a flowchart illustrating a method of processing face information according to one or more embodiments of the present disclosure.

FIG. 2 is a schematic diagram illustrating three-dimensional models of faces represented by different dense point cloud data according to one or more embodiments of the present disclosure.

FIG. 3 is a flowchart illustrating a method of determining dense point cloud data of a first face image under a preset style according to one or more embodiments of the present disclosure.

FIG. 4 is a flowchart illustrating a method of training a neural network according to one or more embodiments of the present disclosure.

FIG. 5 is a flowchart illustrating a specific method of determining dense point cloud data of a first face image under a preset style according to one or more embodiments of the present disclosure.

FIG. 6 is a flowchart illustrating a method of determining a virtual face model of a first face image under a changed style according to one or more embodiments of the present disclosure.

FIG. 7 is a flowchart illustrating a method of generating a virtual face image corresponding to a first face image according to one or more embodiments of the present disclosure.

FIG. 8 is a schematic diagram of determining a virtual face model corresponding to a first face image according to one or more embodiments of the present disclosure.

FIG. 9 is a structural schematic diagram illustrating an apparatus for processing face information according to one or more embodiments of the present disclosure.

FIG. 10 is a schematic diagram illustrating an electronic device according to one or more embodiments of the present disclosure.

### DETAILED DESCRIPTION OF THE EMBODIMENTS

In order to make the objects, technical solutions and advantages of the embodiments of the present disclosure clearer, the technical solutions of the embodiments of the present disclosure will be fully and clearly described below in combination with the accompanying drawings in the embodiments of the present disclosure. Apparently, the embodiments described herein are merely some embodiments of the present disclosure rather than all embodiments. Generally, components of the embodiments of the present disclosure shown in the accompanying drawings may be arranged and designed in different configurations. Therefore, detailed descriptions of the embodiments of the present disclosure provided in the accompanying drawings below are not intended to limit the scope of protection claimed by the present disclosure but only represent some selected embodiments of the present disclosure. Other embodiments obtained by those skilled in the art based on these embodiments without making inventive work shall all fall within the scope of protection of the present disclosure.

It should be noted that similar reference numbers and letters represent similar items in the following drawings. Therefore, once one item is defined in one drawing, it will not be further defined and explained in the subsequent drawings.

The term “and/or” herein is used only to represent three association relationships, for example, A and/or B may refer to that A exists alone, or both A and B exist, or B exists alone. Further, the term “at least one” herein represents any one of multiple or any combination of at least two of multiple, for example, at least one of A, B and C, means any one or more elements selected from a set of A, B and C.

In games and virtual social networking, face modeling technology is often used because different face styles such as classic style, modern style, western style and Chinese style are usually needed in different scenarios. For different face styles, it is required to construct face modeling modes corresponding to different styles. For example, for a face modeling mode for classic style, it is required to collect a large number of face images and respective face models under the classic style, and then train a virtual face model for constructing the classic style based on the collected face images and the respective face models. If another style is desired, a virtual face model for another style also needs to be trained, thereby resulting in poor flexibility and low efficiency.

Based on the study, the present disclosure provides a method of processing face information. In this method, for different first face images, based on dense point cloud data respectively corresponding to multiple second face images of different styles, a virtual face model of the first face image in the corresponding style can be quickly determined, such that the virtual face model can be generated more flexibly so as to improve the generation efficiency of the virtual face model for a face image in a preset style.

To facilitate understanding of the embodiments of the present disclosure, a method of processing face information provided by the embodiments of the present disclosure is firstly introduced in details. The execution subject of the method provided by the embodiments of the present disclosure generally includes a computer device having a computing capability, and the computer device may, for example, include: a terminal device, or a server or another processing device. The terminal device may include a user equipment (UE), a mobile device, a user terminal, a terminal, a handheld device, a computing device, or a wearable device etc. In some possible implementations, the method of processing face information may be implemented by invoking, through a processor, computer readable instructions stored in a memory.

As shown in FIG. 1, an embodiment of the present disclosure provides a method of processing face information. The method includes the following steps S11 to S13.

At step S11, a first face image and dense point cloud data respectively corresponding to multiple second face images of a preset style are obtained.

Illustratively, the first face image may be a color face image collected by an image collection device, or a gray face image, which is not limited herein.

Illustratively, multiple second face images are pre-selected images having some features, which can be used to represent different first face images. For example, n second face images are selected, and for each first face image, the first face image can be represented by using the n second face images and linear fitting coefficients. Illustratively, to enable multiple second face images to represent most first face images in a fitting manner, images of faces having some prominent features over a mean/average face may be selected as the second face images. For example, images of faces having smaller face than a mean face are selected as the second face images, or, images of faces having larger mouth than a mean face are selected as the second face images, or images of faces having larger eyes than a mean face are selected as the second face images.

Illustratively, dense point cloud data respectively corresponding to multiple second face images of different styles, for example, dense point cloud data corresponding to the second face images of cartoon style and dense point cloud data corresponding to the second face images of science fiction style and the like, may be obtained and stored in advance so as to help determine virtual face models of the first face image under different styles subsequently. Illustratively, the virtual face model may include a virtual three-dimensional face model or a virtual two-dimensional face model.

Illustratively, for each second face image, the dense point cloud data corresponding to the second face image and face parameter values of the second face image may be extracted, where the face parameter values includes but not limited to three-dimensional Morphable Face Model (3DMM) parameter values, then, based on the face parameter values, coordinate values of points in dense point cloud are adjusted to obtain dense point cloud data respectively corresponding to multiple second face images of each style of multiple styles, for example, obtain dense point cloud data of each second face image of classic style, dense point cloud data of each second face image of cartoon style, and then the dense point cloud data of each second face image of different styles is stored.

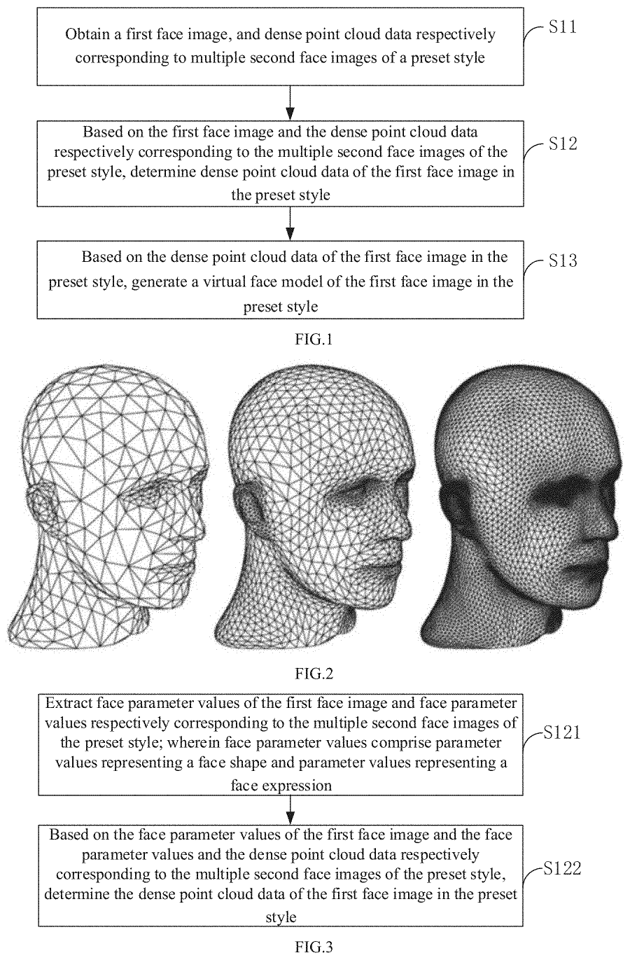

Illustratively, the dense point cloud data may represent a three-dimensional model of a face. Specifically, the dense point cloud data may include coordinate values of multiple vertices of a face surface in a pre-constructed three-dimensional coordinate system, and a three-dimensional mesh (3D-mesh) formed by connecting multiple vertices and the coordinate values of the multiple vertices may be used to represent the three-dimensional model of the face. FIG. 2 shows a schematic diagram illustrating three-dimensional models of faces represented by different dense point cloud data. The larger the number of the points in the dense point cloud is, the finer the three-dimensional model of the face represented by the dense point cloud data is.

Illustratively, the face parameter values include parameter values representing a face shape and parameter values representing a face expression, for example, the face parameter values may include parameter values representing a face shape in K dimensions and parameter values representing a face expression in M dimensions, where the parameter values representing a face shape in K dimensions collectively reflect a face shape of the second face image and the parameter values representing a face expression in M dimensions collectively reflect a face expression of the second face image.

Illustratively, the value of the dimension K is usually in a range of 150-400. The smaller the value of the dimension K is, the simpler the face shape represented is, and the larger the value of the dimension K is, the more complex the face shape represented is. The value of the dimension M is usually in a range of 10-40. The smaller the value of the dimension M is, the simpler the face expression represented is, and the larger the value of the dimension M, the more complex the face expression represented is. Therefore, the embodiments of the present disclosure propose to represent a face using a smaller number of face parameter values so as to help determine a virtual face model corresponding to the first face image.

Illustratively, in combination with the meaning of the face parameter values, the step of adjusting the coordinate values of the dense points corresponding to the dense point cloud data based on the face parameter values to obtain dense point cloud data respectively corresponding to multiple second face images of each style of multiple styles may be understood as adjusting the coordinate values of the vertices in the pre-constructed three-dimensional coordinate system based on the face parameter values and feature attributes respectively corresponding to multiple styles (e.g. feature attribute of cartoon style, feature attribute of classic style etc.) so as to obtain the dense point cloud data respectively corresponding to the second face images of multiple styles.

At step S12, based on the first face image and the dense point cloud data respectively corresponding to multiple second face images of the preset style, dense point cloud data of the first face image in the preset style is determined.

Illustratively, by finding an association relationship between the first face image and the multiple second face images of the preset style, for example, by using a linear fitting manner, linear fitting coefficients between the multiple second face images of the preset style and the first face image may be determined, and further, according to the linear fitting coefficients and the dense point cloud data respectively corresponding to the multiple second face images of the preset style, the dense point cloud data of the first face image under the preset style may be determined.

At step S13, based on the dense point cloud data of the first face image in the preset style, virtual face model of the first face image in the preset style are generated.

After the dense point cloud data of the first face image in the preset style is determined, three-dimensional coordinate values of multiple vertices included in the input face in the pre-constructed three-dimensional coordinate system can be obtained, such that the virtual face model of the first face image in the preset style can be obtained based on the three-dimensional coordinate values of the multiple vertices in the three-dimensional coordinate system.

In the embodiments of the present disclosure, for different multiple styles, according to the dense point cloud data respectively corresponding to multiple second face images of corresponding styles, the virtual face models of the first face image in the corresponding styles may be quickly determined, and thus the virtual face models can be generated more flexibly so as to improve the generation efficiency of the virtual face model of the face image in the preset style.

The steps S11 to S13 will be described below in combination with specific embodiments.

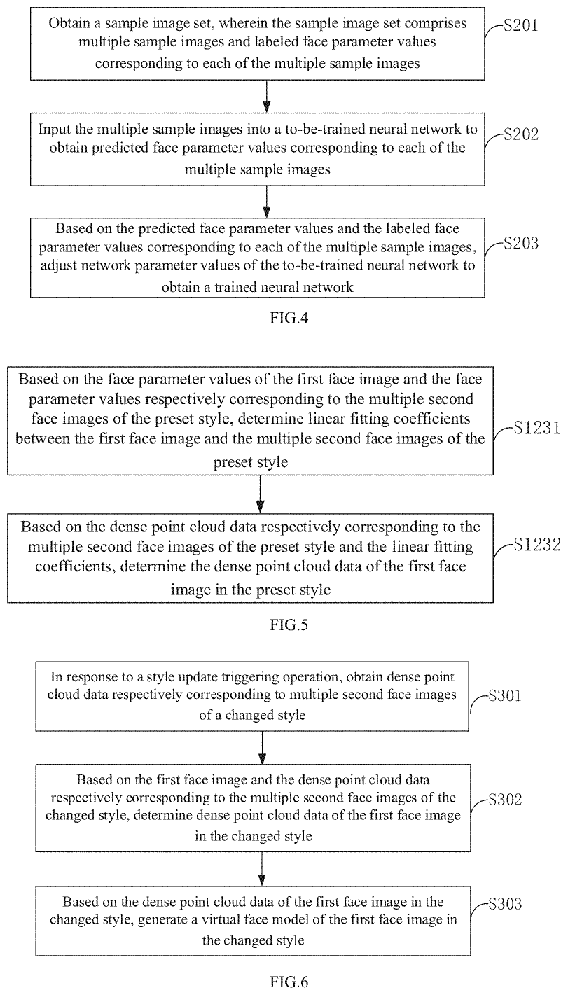

For the above step S12, based on the first face image and the dense point cloud data respectively corresponding to multiple second face images of the preset style, determining the dense point cloud data of the first face image in the preset style may include the following steps S121 to S122 as shown in FIG. 3.

At step S121, face parameter values of the first face image and face parameter values respectively corresponding to multiple second face images of the preset style are extracted, where the face parameter values include parameter values representing a face shape and parameter values representing a face expression.

Illustratively, the face parameter values of the first face image and the face parameter values respectively corresponding to multiple second face images of the preset style may he extracted using a pre-trained neural network herein. For example, the first face image and each second face image may be input into the pre-trained neural network to obtain respective face parameter values.

At step S122, based on the face parameter values of the first face image and the face parameter values and the dense point cloud data respectively corresponding to multiple second face images of the preset style, the dense point cloud data of the first face image in the preset style is determined.

Considering a correspondence between the face parameter values and the dense point cloud data for representing a same face, an association relationship between the first face image and the multiple second face images of the preset style may he determined according to the face parameter values respectively corresponding to the first face image and the multiple second face images, and then, according to the association relationship and the dense point cloud data respectively corresponding to the multiple second face images, the dense point cloud data of the first face image in the preset style is determined.

In the embodiments of the present disclosure, it is proposed that the dense point cloud data of the first face image in the preset style may be determined in combination with the face parameter values of the first face image and the multiple second face images of the preset style. Because a smaller number of face parameter values are used to represent a face, the dense point cloud data of the first face image in the preset style can be determined more quickly.

Illustratively, for face parameter values as mentioned above may be extracted by a neural network pre-trained, the neural network may be obtained by training based on sample images pre-labeled with face parameter values.

In the embodiments of the present disclosure, it is proposed that extracting the face parameter values of a face image by using the pre-trained neural network can increase the extraction efficiency and accuracy for the face parameter values.

Specifically, the neural network may be pre-trained in the following manner. As shown in FIG. 4, it includes the following steps S201 to S203.

At step S201, a sample image set is obtained, where the sample image set includes multiple sample images and labeled face parameter values corresponding to each of the multiple sample images.

At step S202, multiple sample images are input into a to-be-trained neural network to obtain predicted face parameter values corresponding to each of the multiple sample images.

At step S203, based on the predicted face parameter values and the labeled face parameter values corresponding to each of the multiple sample images, network parameter values of the to-be-trained neural network are adjusted to obtain a trained neural network,

Illustratively, a large number of face images and the labeled face parameter values corresponding to each face image may be collected as the sample image set herein, and each sample image is input into the to-be-trained neural network to obtain the predicted face parameter values corresponding to each sample image and output by the to-be-trained neural network, and further, a loss value corresponding to the to-be-trained neural network may be obtained based on the labeled face parameter values and the predicted face parameter values corresponding to the sample images, and then the network parameter values of the to-be-trained neural network are adjusted based on the loss value until an adjustment number reaches a preset number and/or a third loss value is less than a third preset threshold, so as to obtain a trained neural network.

In the embodiments of the present disclosure, during a process of training a neural network for extracting face parameter values, it is proposed that continuous adjustments are performed for the network parameter values of the neural network based on the labeled face parameter values of each sample image so as to obtain a neural network with high accuracy.

Specifically, for the above step S122, based on the face parameter values of the first face image and the face parameter values and the dense point cloud data respectively corresponding to multiple second face images of the preset style, determining the dense point cloud data of the first face image under the preset style, includes the following steps S1231 to S1232 as shown in FIG. 5.

At step S1231, based on the face parameter values of the first face image and the face parameter values respectively corresponding to the multiple second face images of the preset style, linear fitting coefficients between the first face image and the multiple second face images of the preset style are determined.

At step S1232, based on the dense point cloud data respectively corresponding to the multiple second face images of the preset style and the linear fitting coefficients, the dense point cloud data of the first face image in the preset style is determined.

Illustratively, with the face parameter values as 3DMM parameter values, since the 3DMM parameter values of the first face image may represent face shape and face expression corresponding to the first face image and likewise, the 3DMM parameter values corresponding to each second face image may represent face shape and face expression corresponding to the second face image, the association relationship between the first face image and the multiple second face images may be determined based on the 3DMM parameter values. Specifically, if the multiple second face images include n second face images, the linear fitting coefficients between the first face image and the multiple second face images also include n sets of linear fitting coefficient values. The association relationship between the face parameter values of the first face image and the face parameter values respectively corresponding to the multiple second face images may he expressed in the following formula (1):

$${IN}_{3 DMM} = {\sum }_{x = 1}^{L} {α}_{x} {BASE}_{3 DMM ( x )} \qquad ( 1 )$$

Where, represents the IN_{3DMM} parameter values corresponding to the first face image; αₓ represents linear fitting coefficient values between the first face image and the x-th second face image; BASE_{3DMM(x)} represents the face parameter values corresponding to the x-th second face image; L represents a number of the second face images used for determining the face parameter values corresponding to the first face image; x is used to indicate the x-th second face image, where x∈(1, L).

In the embodiments of the present disclosure, it is proposed that linear fitting coefficients indicating an association relationship between the first face image and the multiple second face images of a preset style are obtained quickly by use of a smaller number of face parameter values, and further, the dense point cloud data of the multiple second face images of the preset style may he adjusted based on the linear fitting coefficients so as to quickly obtain the dense point cloud data of the first face image in the preset style.

Specifically, based on the face parameter values of the first face image and the face parameter values respectively corresponding to the multiple second face images of the preset style, determining the linear fitting coefficients between the first face image and the multiple second face images of the preset style, may include the following steps S12311 to S12314.

At step S12311, current linear fitting coefficients is obtained, where the current linear fitting coefficients include preset initial linear fitting coefficients.

The current linear fitting coefficients may be linear fitting coefficients adjusted at least one time through the following steps S12312 to S12314, or initial linear fitting coefficients. When the current linear fitting coefficients are initial linear fitting coefficients, the initial linear fitting coefficients may be preset based on experiences.

At step S12312, based on the current linear fitting coefficient and the face parameter values respectively corresponding to the multiple second face images, current face parameter values of the first face image is predicted.

Illustratively, the face parameter values respectively corresponding to the multiple second face images may be extracted by the above pre-trained neural network, and then, the current linear fitting coefficients and the face parameter values respectively corresponding to the multiple second face images are input into the above formula (1) to predict the current face parameter values of the first face image.

At step S12313, based on the predicted current face parameter values and the face parameter values of the first face image, a current loss value is determined.

During a process of adjusting the linear fitting coefficients, a difference between the predicted current face parameter values of the first face image and the face parameter values of the first face image extracted using the above pre-trained neural network may be present, and the current loss value may be determined based on the difference.

At step S12314, based on the current loss value and a constraint range corresponding to the preset linear fitting coefficients, the current linear fitting coefficients are adjusted to obtain adjusted linear fitting coefficients, and the adjusted linear fitting coefficients are taken as the current linear fitting coefficients to return to perform the step of predicting the current face parameter values until, in response to determining that an operation for adjusting the current linear fitting coefficients satisfies an adjustment cutoff condition, the linear fitting coefficients between the first face image and the multiple second face images of the preset style are obtained based on the current linear fitting coefficients.

Illustratively, considering the face parameter values are used to represent face shape and size, in order to prevent subsequent distortion of the dense point cloud data of the first face image determined based on the linear fitting coefficients when representing the virtual face model, it is proposed here that, when the current linear fitting coefficients are adjusted based on the current loss value, it is required to combine with the constraint range of the preset linear fitting coefficients. For example, herein, based on a large quantity of data statistics, it is determined that the constraint range corresponding to the preset linear fitting coefficients is set to be between −0.5 and 0.5. In this way, when the current linear fitting coefficients are adjusted based on the current loss value, each adjusted linear fitting coefficient is between −0.5 and 0.5.

Illustratively, based on the current loss value and the constraint range corresponding to the preset linear fitting coefficients, the current linear fitting coefficients are adjusted such that the predicted current face parameter values are more approximate to the face parameter values extracted based on the neural network, and then, the adjusted linear titling coefficients are taken as the current linear fitting coefficients to return to perform step S12312 until the current loss value is less than a preset threshold and/or the number of repeated adjustments reaches a preset number, so as to obtain the linear fitting coefficients.

In the embodiments of the present disclosure, in a process of adjusting the linear fitting coefficients between the first face image and the multiple second face images, several adjustments are performed for the linear fitting coefficients based on the loss value and/or adjustment number, so as to improve the accuracy of the linear fitting coefficients; on the other hand, during the adjustment process, adjustment constraining is performed based on the constraint range of the preset linear fitting coefficients, such that the dense point cloud data of the first face image in the preset style can be determined more reasonably based on the obtained linear fitting coefficients.

Specifically, the dense point cloud data includes coordinate values of multiple corresponding dense points. For the above step S1232, based on the dense point cloud data respectively corresponding to multiple second face images of the preset style and the linear fitting coefficients, determining the dense point cloud data of the first face image under the preset style may include the following steps S12321 to S12324.

At step S12321, based on the coordinate values of the dense points respectively corresponding to the multiple second face images of the preset style, coordinate values of corresponding points in average dense point cloud data are determined.

Illustratively, the coordinate value of each point in the average dense point cloud data corresponding to the multiple second face images of the preset style may be determined based on the coordinate values of the dense points respectively corresponding to the multiple second face images and a number of the multiple second face images. For example, the multiple second face images include 10 images and the dense point cloud data corresponding to each second face image includes three-dimensional coordinate values of 100 points, For the first point, the three-dimensional coordinate values corresponding to the first points in the 10 second face images are summed, and then the summing result is divided by 10 to obtain a value as a coordinate value of the corresponding first point in the average dense point cloud data. In the same way, the coordinate value of each point in the average point cloud data corresponding to multiple second face images under the three-dimensional coordinate system can be obtained. In other words, the mean value of the coordinate values of mutually-corresponding points in respective dense point cloud data of the multiple second face images forms the coordinate value of the corresponding points in the average dense point cloud data.

At step S12322, based on the coordinate values of the dense points respectively corresponding to multiple second face images and the coordinate values of corresponding points in the average dense point cloud data, coordinate difference values respectively corresponding to the multiple second face images are determined.

Illustratively, the coordinate values of the points in the average dense point cloud data may represent an average virtual face model corresponding to multiple second face images, for example, a facial feature size (e.g. the size of eyes, eyebrows, ears, a nose, or a mouth) represented by the coordinate values of the points in the average dense point cloud data may be an average facial feature size corresponding to the multiple second face images, a face size represented by the coordinate values of the points in the average dense point cloud data may be an average face size corresponding to the multiple second face images and the like.

Illustratively, by performing subtraction for the coordinate values of the dense points respectively corresponding to the multiple second face images and the coordinate values of the corresponding points in the average dense point cloud data, coordinate difference values of the coordinate values of the dense points respectively corresponding to the multiple second face images relative to the coordinate values of the corresponding points in the average dense point cloud data (or, abbreviated as “the coordinate difference values corresponding, to the second face image” herein) can be obtained, thereby representing a difference between the second face image and a mean face image.

At step S12323, based on the coordinate difference values respectively corresponding to the multiple second face images and the linear fitting coefficients, coordinate difference values corresponding to the first face image are determined.

Illustratively, the linear fitting coefficients may represent an association relationship between the face parameter values of the first face image and the face parameter values respectively corresponding to multiple second face images and there are correspondences between the face parameter values of the face image and the dense point cloud data corresponding to the face image. Therefore, the linear fitting coefficients may also represent an association relationship between the dense point cloud data corresponding to the first face image and the dense point cloud data respectively corresponding to multiple second face images.

In a case of corresponding to a same average dense point cloud data, the linear fitting coefficients may also represent an association relationship between the coordinate difference values corresponding to the first face image and the coordinate difference values respectively corresponding to multiple second face images. Therefore, based on the coordinate difference values respectively corresponding to multiple second face images and the linear fitting coefficients, the coordinate difference values of the dense point cloud data corresponding to the first face image relative to the average dense point cloud data may be determined.

At step S12324, based on the coordinate difference values corresponding to the first face image and the coordinate values of the corresponding points in the average dense point cloud data, the dense point cloud data of the first face image in the preset style is determined.

By performing summing for the coordinate difference values corresponding to the first face image and the coordinate values of the corresponding points in the average dense point cloud data, the dense point cloud data corresponding to the first face image may be obtained, which specifically includes coordinate values of the dense points corresponding to the first face image. Based on the dense point cloud data, a virtual face model corresponding to the first face image can be represented.

Specifically, the dense point cloud data corresponding to the first face image may be determined through following methods. Considering the relationship between the dense point cloud data and the 3DMM, the dense point cloud data corresponding to the first face image can be represented by OUT_{3dmesh}, which specifically may be determined in the following formula (2):

$${OUT}_{3 mesh} = {\sum }_{x = 1}^{L} {α}_{x} * ( {BASE}_{3 dmesh ( x )} - {MEAN}_{3 dmesh} ) + {MEAN}_{3 dmesh} \qquad ( 2 )$$

where, BASE_{3dmeh(x)} represents coordinate values of dense points corresponding to the x-th second face image; MEAN_{3dmeh} represents coordinate values of corresponding points in the average dense point cloud data determined based on multiple second face images;

$${\sum }_{x = 1}^{L} {α}_{x} * ( {BASE}_{3 dmesh ( x )} - {MEAN}_{3 dmesh} )$$

represents coordinate difference values of the coordinate values of the dense points corresponding to the first face image relative to the coordinate values of the corresponding points in the average dense point cloud data.

When the dense point cloud data of the first face image is determined by the steps S12321 to S12324, i.e. the formula, (2). Compared with determining the dense point cloud data corresponding to the first face image based on the dense point cloud data respectively corresponding to multiple second face images and the linear fitting coefficients, the above manner includes the following advantages.

In the embodiments of the present disclosure, since the linear fitting coefficients are used to perform linear fitting for the coordinate difference values respectively corresponding to multiple second face images, the coordinate difference values of the coordinate values of the dense points corresponding to the first face image relative to the coordinate values of the corresponding points in the average dense point cloud data (or, abbreviated as “the coordinate difference values corresponding to the first face image” herein) can be obtained. Therefore, it is no need to define that a sum of these linear fitting coefficients is equal to 1, and the dense point cloud data representing a normal face can be obtained by adding up the coordinate difference values corresponding to the first face image and the coordinate values of the corresponding points in the average dense point cloud data.

Furthermore, in a case of fewer second face images, the linear fitting coefficients may be reasonably adjusted based on the manner provided by the embodiments of the present disclosure, such that the dense point cloud data corresponding to the first face image can be determined by using a smaller number of second face images. For example, the size of the eyes of the first face image is small, in the above manner, there is no need to define the eye sizes of multiple second face images but adjust the coordinate difference values based on the linear fitting coefficients, such that the dense point cloud data representing the small eyes can be obtained by superimposing the adjusted coordinate difference values and the coordinate values of the corresponding points in the average dense point cloud data. Specifically, when multiple second face images include big eyes, the eyes represented by the corresponding average dense point cloud data are also big eyes, and the linear fitting coefficients can be still adjusted such that the dense point cloud data representing small eyes can be obtained by performing summing for the adjusted coordinate difference values and the coordinate values of the corresponding points in the average dense point cloud data.

Thus, in the embodiments of the present disclosure, for different first face images, it is not required to select the second face images similar in facial features to the first face image to determine the dense point cloud data corresponding to the first face image. In this way, in a case of fewer second face images, the dense point cloud data of different first face images in the preset style may be accurately represented by using the dense point cloud data of multiple second face images.

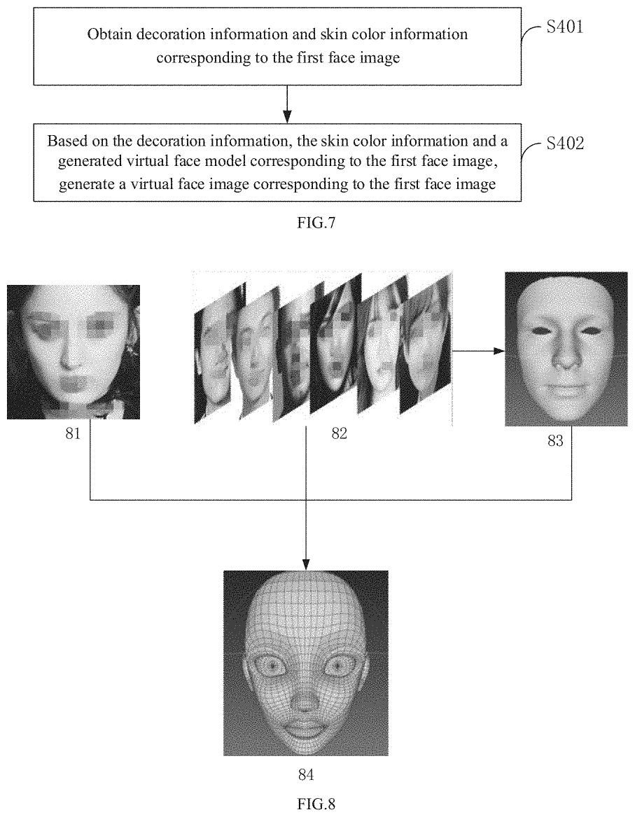

In the above manner, the virtual face model of the first face image in the preset style may be obtained, for example, a virtual face model of the first face image in a classic style is obtained. When it is required to adjust the style of the virtual face model corresponding to the first face image, tier example, generate a virtual face model of the first face image in a modern style, in one implementation, as shown in FIG. 6, the method of the embodiments of the present disclosure further includes: in response to a style update triggering operation, obtaining a virtual face model of the first face image in a changed style, which specifically includes the following steps S301 to S303.

At step S301, in response to a style update triggering operation, dense point cloud data respectively corresponding to multiple second face images of a changed style is obtained.

Illustratively, since the dense point cloud data respectively corresponding to multiple second face images of multiple styles may be stored in advance, after receiving the style update triggering operation, the dense point cloud data of each second face image of a changed style may be directly obtained.

At step S302, based on the first face image and the dense point cloud data respectively corresponding to multiple second face images of changed style, dense point cloud data of the first face image in the changed style is determined.

The manner of determining the dense point cloud data of the first face image under the changed style herein is similar to the above manner of determining the dense point cloud data of the first face image under the preset style and will not be repeated herein.

At step S303, based on the dense point cloud data of the first face image in the changed style, a virtual face model of the first face image in the changed style is generated.

Likewise, the manner of generating the virtual face model of the first face image in the changed style herein is similar to the manner of generating the virtual face model of the first face image in the preset style based on the dense point cloud data of the first face image in the preset style and will not be repeated herein.

In the embodiments of the present disclosure, after the style update triggering operation is detected, the virtual face model of the first face image in the changed style may be quickly obtained based directly on the pre-stored dense point cloud data of multiple second face images of a changed style, thus improving the efficiency of generating the virtual face models of the first face image in different styles.

In some scenarios, after the virtual face model is obtained, it is further required to generate a virtual face image corresponding to the first face image, where the virtual face image may be a three-dimensional face image or a two-dimensional face image. In one implementation, as shown in FIG. 7, the method provided by the embodiments of the present disclosure further includes the following steps:

At step S401, decoration information and skin color information corresponding to the first face image are obtained.

At step S402, based on the decoration information, the skin color information and the virtual face model corresponding to the first face image, a virtual face image corresponding to the first face image is generated.

Illustratively, the decoration information may include hair style and hair accessory etc. The decoration information and the skin color information may be obtained by performing image recognition for the first face image or obtained as selected by a user. For example, a virtual face image generation interface provides an option column for decoration information and skin color information and the decoration information and the skin color information corresponding to the first face image may be determined based on a selection result by the user in the option column.

Furthermore, after the decoration information and the skin color information included in the first face image are determined, the virtual face image corresponding to the first face image may be generated based on the virtual face model of the first face image, where the first face model of the first face image may be a virtual face model for the first face image in a preset style, or a virtual face model for the first face image in a changed style. In this way, the generated virtual face image may be a virtual face image having a specific style.

In the embodiments of the present disclosure, the virtual face image corresponding to the first face image may be generated based on the decoration information and the skin color information selected by the user, so as to improve interaction with the user and increase user experiences.

A process of processing face information will be elaborated below with a specific embodiment. The process includes the following steps S501 to S507.

At step S501, a sample image set is obtained, where the sample image set includes multiple sample images and 3DMM parameter values corresponding to each sample image.

At step S502, a neural network is trained based on the sample image set to obtain a neural network capable of predicting the 3DMM parameter values corresponding to a face image.

At step S503, by using the trained neural network, 3DMM parameter values IN_{3DMM} corresponding to the first face image and 3DMM parameter values BASE_{3DMM} corresponding to multiple second face images are determined.

At step S504, based on IN_{3DMM} and BASE_{3DMM}, weight values α at the time of representing IN_{3DMM} using BASE_{3DMM}, are determined. The α may be determined by the formula: IN_{3DMM}=αBASE_{3DMM}, where the α may represent linear fitting coefficients between the first face image and multiple second face images.

At step S505, the α at step 504 is optimized continuously by using a machine learning algorithm, such that IN3dmm is made approximate to α*BASE3dmm as possible, and during the optimization process, the values of the α are constrained to enable the values of α to be in a range of −0.5 and 0.5.

At step S506, based on 3D-meshes (may be represented by BASE_{3dmm}) respectively corresponding to multiple second face images, a 3D-mesh (represented by MEAN_{3dmeh}) corresponding to an mean face image is determined, where 3D-mesh may be determined based on dense point cloud data and a relationship between 3D-mesh and dense point cloud data may be referred to the above descriptions for FIG. 2.

At step S507, based on BASE_{3dmeh} corresponding to multiple second face images, MEAN_{3dmeh} corresponding to the mean face image, and OUT_{3DMM}α(BASE₃ₘₑₛₕ−MEAN₃ₘₑₛₕ)+MEAN_{3dmesh}, 3D-mesh (i.e. OUT_{3dmesh}) of the first face image is determined.

The above steps S501 to S502 may be completed before processing the first face image. When processing a new first face image received each time, processing may be started from step S503. Of course, if only a virtual face model for the first face image in a changed style is to be determined, processing may be started from step S506. Therefore, after a neural network capable of predicting the 3DMM parameter values corresponding to a face image is obtained, virtual face model for the first face image obtained each time in a preset style may be quickly determined. After linear fitting coefficients between the first face image and multiple second face images of different styles are obtained, when it is required to change style for a specified first face image, the virtual face models for the first face image in different styles may be quickly obtained.

FIG. 8 is a schematic diagram illustrating a process of determining a virtual face model corresponding to a first face image 81. As shown in FIG. 8, a mean face image 83 may be determined based on multiple second face images 82 of a preset style, and then, based on the first face image 81, the multiple second face images 82 and the mean face image 83, the virtual face model 84 of the first face image in the preset style is determined.

Those skilled in the art may understand, in the above method of specific implementations, the drafting sequence of various steps does not mean a strict execution sequence to constitute any limitation to the implementation process, and the specific execution sequence of various steps shall be determined based on its functions and possible internal logics.

Based on a same technical idea, an embodiment of the present disclosure further provides an apparatus for processing face information corresponding to the above method of processing face information. Since the principle of the apparatus of the embodiment of the present disclosure for solving problems is similar to the above method of the embodiments of the present disclosure, the implementation of the apparatus may be referred to the method implementation and thus will not be repeated herein.

As shown in FIG. 9, an embodiment of the present disclosure provides an apparatus 600 for processing face information. The apparatus 600 for processing face information may include the following modules:
an obtaining module 601, configured to obtain a first face image, and dense point cloud data respectively corresponding to multiple second face images of a preset style;
a determining module 602, configured to, based on the first face and the dense point cloud data respectively corresponding to the multiple second face images of the preset style, determine dense point cloud data of the first face image in the preset style;
a generating module 603, configured to, based on the dense point cloud data of the first face image in the preset style, generate a virtual face model of the first face image in the preset style.

In a possible implementation, when used to, based on the first face image and the dense point cloud data respectively corresponding to the multiple second face images of the preset style, determine the dense point cloud data of the first face image in the preset style, the determining module 602 is configured to:
extract face parameter values of the first face image and face parameter values respectively corresponding to the multiple second face images of the preset style, where the face parameter values include parameter values representing a face shape and parameter values representing a face expression;
based on the face parameter values of the first face image and the face parameter values and the dense point cloud data respectively corresponding to the multiple second face images of the preset style, determine the dense point cloud data of the first face image in the preset style.

In a possible implementation, when used to, based on the face parameter values of the first face image and the face parameter values and the dense point cloud data respectively corresponding to the multiple second face images of the preset style, determine the dense point cloud data of the first face image in the preset style, the determining module 602 is configured to:
based on the face parameter values of the first face image and the face parameter values respectively corresponding to the multiple second face images of the preset style, determine linear fitting coefficients between the first face image and the multiple second face images;
based on coordinate values of dense points respectively corresponding to the multiple second face images of the preset style, coordinate values of corresponding points in average dense point cloud data and the linear fitting coefficients, determine the dense point cloud data of the first face image in the preset style.

In a possible implementation, when used to, based on the face parameter values of the first face image and the face parameter values respectively corresponding to the multiple second face images of the preset style, determine the linear fitting coefficients between the first face image and the multiple second face images, the determining module 602 is configured to:
obtain current linear fitting coefficients, where the current linear fitting coefficients include preset initial linear fitting coefficients;
based on the current linear fitting coefficients and the face parameter values respectively corresponding to the multiple second face images of the preset style, predict current face parameter values of the first face image;
based on the predicted current face parameter values, the face parameter values of the first face image and a constraint range corresponding to the preset linear fitting coefficients, determine a current loss value;
based on the current loss value, adjust e current linear fitting coefficients to obtain adjusted linear fitting coefficients; and
by taking the adjusted linear fitting coefficients as the current linear fitting coefficients, return to perform the step of predicting the current face parameter values, until, in a case that an operation for adjusting the current linear fitting coefficients satisfies an adjustment cutoff condition, the linear fitting coefficients are obtained based on the current linear fitting coefficients.

In a possible implementation, dense point cloud data includes coordinate values of multiple corresponding dense points; when used to, based on the dense point cloud data respectively corresponding to the multiple second face images of the preset style and the linear fitting coefficients, determine the dense point cloud data of the first face image in the preset style, the determining module 602 is configured to:
based on coordinate values of dense points respectively corresponding to the multiple second face images of the preset style, determine coordinate values of corresponding points in average dense point cloud data;
based on the coordinate values of the dense points respectively corresponding to the multiple second face images and the coordinate values of the corresponding points in the average dense point cloud data, determine coordinate difference values respectively corresponding to the multiple second face images;
based on the coordinate difference values respectively corresponding to the multiple second face images and the linear fitting coefficients, determine coordinate difference values corresponding to the first face image;
based on the coordinate difference values corresponding to the first face image and the coordinate values of the corresponding points in the average dense point cloud data, determine the dense point cloud data of the first face image in the preset style.

In a possible implementation, the apparatus further includes an updating module 604, which is configured to:
in response to a style update triggering operation, obtain dense point cloud data respectively corresponding to multiple second face images of a changed style;
based on the first face image and the dense point cloud data respectively corresponding to the multiple second face images of the changed style, determine dense point cloud data of the first face image in the changed style;
based on the dense point cloud data of the first face image in the changed style, generate a virtual face model of the first face image in the changed style.

In a possible implementation, the generating module 603 is further configured to:
obtain decoration information and skin color information corresponding to the first face image;
based on the decoration information, the skin color information and a generated virtual face model corresponding to the first face image, generate a virtual face image corresponding to the first face image.

In a possible implementation, the face parameter values are extracted by a neural network pre-trained, and the neural network is obtained by training based on sample images pre-labeled with face parameter values.

In a possible implementation, the apparatus further includes a training module 606 which is configured to train the neural network in the following manner:
obtaining a sample image set, where the sample image set includes multiple sample images and labeled face parameter values corresponding to each of the multiple sample images;
inputting the multiple sample images into a to-be-trained neural network to obtain predicted face parameter values corresponding to each of the multiple sample images;
based on the predicted face parameter values and the labeled face parameter values corresponding to each of the multiple sample images, adjusting network parameter values of the to-be-trained neural network to obtain a trained neural network.

The processing flows of various modules in the apparatus and interactive flows between various modules may be referred to relevant descriptions of the method embodiments and will not be repeated herein.

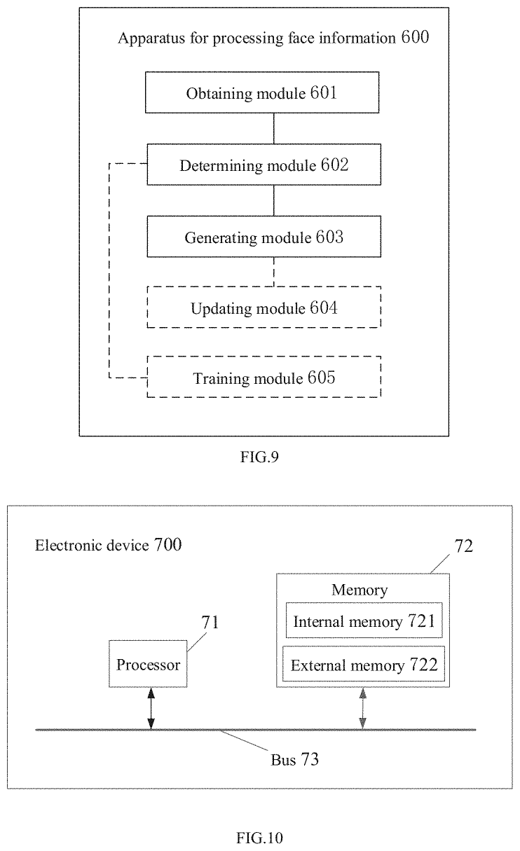

Corresponding to the method of processing face information in FIG. 1, an embodiment of the present disclosure further provides an electronic device 700. As shown in FIG. 10, the electronic device 700 may include a processor 71, a memory 72 and a bus 73, The memory 72 is configured to store executable instructions and includes an internal memory 721 and an external memory 722. The internal memory 721 is also called internal storage device configured to temporarily store operational data of the processor 71 and data exchanged with the external memory 722 such as hard disk. The processor 71 exchanges data with the external memory 722 through the internal memory 721. When the electronic device 700 runs, the processor 71 communicates with the memory 72 via the bus 73 to perform the following instructions: obtaining a first face image and dense point cloud data respectively corresponding to multiple second face images of a preset style; based on the first face image and the dense point cloud data respectively corresponding to the multiple second face images of the preset style, determining dense point cloud data of the first face image in the preset style; based on the dense point cloud data of the first face image in the preset style, generating a virtual face model of the first face image in the preset style.

An embodiment of the present disclosure further provides a computer readable storage medium storing computer programs, where the computer programs are executed by a processor to implement the steps of the method of processing face information as mentioned in the above method embodiments. The storage medium may be a volatile or non-volatile computer readable storage medium.

An embodiment of the present disclosure further provides a computer program product carrying program codes, where instructions included in the program codes are used to perform the steps of the method of processing face information as mentioned in the above method embodiments. Therefore, the relevant details may be referred to the above method embodiments and will not be repeated herein.

The above computer program product may be specifically implemented by hardware, or software or combination thereof. In an optional embodiment, the computer program product is specifically embodied as computer storage medium. In another optional embodiment, the computer program product is specifically embodied as software product such as software development kit (SDK) and the like.

Those skilled in the art may clearly understand that, for convenience and clarity of descriptions, the specific working processes of the above system and apparatus may be referred to the corresponding processes of the preceding method embodiments and will not be repeated herein. In the several embodiments provided by the present disclosure, it should be understood that the disclosed system, apparatus and method may be implemented in other manners. The described apparatus embodiments are merely illustrative, for example, the division of units is only a logical functional division and in actual implementation, the division may be achieved in another manner. For another example, several units or assemblies may be combined or integrated into another system or some features may be neglected or not executed. For another point, mutual coupling or direct coupling or communication connection displayed or discussed may be achieved through some communication interfaces, and indirect coupling or communication connection of the apparatus or units may be in electrical or mechanical or other form.

The units described as separate members may he or not be physically separated, and the members displayed as units may be or not be physical units, i.e., may be located in one place, or may be distributed to multiple network units. Part or all of the modules may be selected according to actual requirements to implement the objectives of the solutions in the embodiments.

Furthermore, various functional units in various embodiments of the present disclosure may be integrated into one processing unit, or may be present physically separately, or two or more units thereof may be integrated into one unit.

The functions, if implemented in the form of software functional units and sold or used as independent products, may be stored in a processor-executable non-volatile computer-readable storage medium. Based on such understanding, the technical scheme of the present disclosure essentially or a part contributing to the prior art or part of the technical scheme may be embodied in the form of a software product, the software product is stored in a storage medium, and includes several instructions for enabling a computer device (such as a personal computer, a server or a network device) to execute all or part of the steps of the method disclosed by the embodiments of the present disclosure; and the above storage mediums include various mediums such as a USB disk, a mobile hard disk, a read-only memory (ROM), a random access memory (RAM), a diskette or a compact disk and the like which may store program codes.

Finally, it should be noted that the above embodiments are merely specific implementations of the present disclosure which are used to describe the technical solutions of the present disclosure rather than limit the present disclosure. The scope of protection of the present disclosure is not limited hereto. Although detailed descriptions are made to the present disclosure by referring to the preceding embodiments, those skilled in the art should understand that any person of this prior art may still make modifications or easily conceivable changes to the technical solutions recorded in the above embodiments or make equivalent substitutions to part of technical features therein within the technical scope of the present disclosure. Such modifications, changes and substitutions will not cause the essence of the corresponding technical solutions to depart from the spirit and scope of the technical solutions of the embodiments of the present disclosure and shall all fall within the scope of protection of the present disclosure. Therefore, the scope of protection of the present disclosure is indicated by the appended claims.

1. A computer-implemented. method of processing face information, comprising:
obtaining a first face image and dense point cloud data, the dense point cloud data respectively corresponding to multiple second face images of a preset style;
based on the first face image and the dense point cloud data respectively corresponding to the multiple second face images of the preset style, determining dense point cloud data of the first face image in the preset style; and
based on the dense point cloud data of the first face image in the preset style, generating a virtual face model of the first face image in the preset style.

2. The computer-implemented method of claim 1. wherein determining the dense point cloud data of the first face image in the preset style comprises:
extracting face parameter values of the first face image and face parameter values respectively corresponding to the multiple second face images of the preset style, wherein face parameter values of a face image comprise parameter values representing a face shape in the face image and parameter values representing a face expression in the face image; and
based on the face parameter values of the first face image and the face parameter values and the dense point cloud data respectively corresponding to the multiple second face images of the preset style, determining the dense point cloud data of the first face image in the preset style.

3. The computer-implemented method of claim 2, wherein determining the dense point cloud data of the first face image in the preset style comprises:
based on the face parameter values of the first face image and the face parameter values respectively corresponding to the multiple second face images of the preset style, determining linear fitting coefficients between the first face image and the multiple second face images of the preset style; and
based on the dense point cloud data respectively corresponding to the multiple second face images of the preset style and the linear fitting coefficients, determining the dense point cloud data of the first face image in the preset style.

4. The computer-implemented method of claim 3, wherein determining the linear fitting coefficients between the first face image and the multiple second face images of the preset style comprises:
obtaining current linear fitting coefficients, wherein the current linear fitting coefficients comprise preset initial linear fitting coefficients;
based on the current linear fitting coefficients and the face parameter values respectively corresponding to the multiple second face images, predicting current face parameter values of the first face image;
based on the predicted current face parameter values and the face parameter values of the first face image, determining a current loss value;
based on the current loss value and a constraint range corresponding to the preset linear fitting coefficients, adjusting the current linear fitting coefficients to obtain adjusted linear fitting coefficients; and
by taking the adjusted linear fitting coefficients as the current linear fitting coefficients, returning to perform predicting the current face parameter values, until an operation for adjusting the current linear fitting coefficients satisfies an adjustment cutoff condition, and in response, obtaining the linear fitting coefficients between the first face image and the multiple second face images of the preset style based on the current linear fitting coefficients.

5. The computer-implemented method of claim 3, wherein dense point cloud data comprises coordinate values of multiple corresponding dense points, and
wherein determining the dense point cloud data of the first face image in the preset style comprises:
based on coordinate values of dense points respectively corresponding to the multiple second face images of the preset style, determining coordinate values of corresponding points in average dense point cloud data;
based on the coordinate values of the dense points respectively corresponding to the multiple second face images and the coordinate values of the corresponding points in the average dense point cloud data, determining coordinate difference values respectively corresponding to the multiple second face images;
based on the coordinate difference values respectively corresponding to the multiple second face images and the linear fitting coefficients, determining coordinate difference values corresponding to the first face image; and
based on the coordinate difference values corresponding to the first face image and the coordinate values of the corresponding points in the average dense point cloud data, determining the dense point cloud data of the first face image in the preset style.

6. The computer-implemented method of claim 2, wherein the face parameter values of the face image are extracted by a neural network that is pre-trained based on sample images pre-labeled with corresponding face parameter values.

7. The computer-implemented method of claim 6, wherein the neural network is pre-trained by:
obtaining a sample image set, wherein the sample image set comprises multiple sample images and labeled face parameter values corresponding to each of the multiple sample images;
inputting the multiple sample images into a to-be-trained neural network to obtain predicted face parameter values corresponding to each of the multiple sample images; and
based on the predicted face parameter values and the labeled face parameter values corresponding to each of the multiple sample images, adjusting network parameter values of the to-be-trained neural network to obtain a trained neural network.

8. The computer-implemented method of claim 1, further comprising:
in response to a style update triggering operation, obtaining dense point cloud data respectively corresponding to multiple second face images of a changed style;
based on the first face image and the dense point cloud data respectively corresponding to the multiple second face images of the Changed style, determining dense point cloud data of the first face image in the changed style; and
based on the dense point cloud data of the first face image in the changed style, generating a virtual face model of the first face image in the changed style.

9. The computer-implemented method of claim 1, further comprising:
obtaining decoration information and skin color information corresponding to the first face image; and
based on the decoration information, the skin color information, and a generated virtual face model corresponding to the first face image, generating a virtual face image corresponding to the first face image.

10. An electronic device, comprising:
at least one processor;
at least one memory; and
a bus,
wherein the at least one memory is coupled to the at least one processor via the bus and stores programming instructions for execution by the at least one processor to perform operations comprising:
obtaining a first face image and dense point cloud data, the dense point cloud data respectively corresponding to multiple second face images of a preset style;
based on the first face image and the dense point cloud data respectively corresponding to the multiple second face images of the preset style, determining dense point cloud data of the first face image in the preset style; and
based on the dense point cloud data of the first face image in the preset style, generating a virtual face model of the first face image in the preset style.

11. The electronic device of claim 10, wherein determining the dense point cloud data of the first face image in the preset style comprises:
extracting face parameter values of the first face image and face parameter values respectively corresponding to the multiple second face images of the preset style, wherein face parameter values of a face image comprise parameter values representing a face shape in the face image and parameter values representing a face expression in the face image; and
based on the face parameter values of the first face image and the face parameter values and the dense point cloud data respectively corresponding to the multiple second face images of the preset style, determining the dense point cloud data of the first face image in the preset style.

12. The electronic device of claim 11, wherein determining the dense point cloud data of the first face image in the preset style comprises:
based on the face parameter values of the first face image and the face parameter values respectively corresponding to the multiple second face images of the preset style, determining linear fitting coefficients between the first face image and the multiple second face images of the preset style; and
based on the dense point cloud data respectively corresponding to the multiple second face images of the preset style and the linear fitting coefficients, determining the dense point cloud data of the first face image in the preset style.

13. The electronic device of claim 12, wherein determining the linear fitting coefficients between the first face image and the multiple second face images of the preset style comprises:
obtaining current linear fitting coefficients, wherein the current linear fitting coefficients comprise preset initial linear fitting coefficients;
based on the current linear fitting coefficients and the face parameter values respectively corresponding to the multiple second face images, predicting current face parameter values of the first face image; and
based on the predicted current face parameter values and the face parameter values of the first face image, determining a current loss value;
based on the current loss value and a constraint range corresponding to the preset linear fitting coefficients, adjusting the current linear fitting coefficients to obtain adjusted linear fitting coefficients; and
by taking the adjusted linear fitting coefficients as the current linear fitting coefficients, returning to perform predicting the current face parameter values, until an operation for adjusting the current linear fitting coefficients satisfies an adjustment cutoff condition, and in response, obtaining the linear fitting coefficients between the first face image and the multiple second face images of the preset style based on the current linear fitting coefficients.

14. The electronic device of claim 12, wherein dense point cloud data comprises coordinate values of multiple corresponding dense points, and
wherein determining the dense point cloud data of the first face image in the preset style comprises:
based on coordinate values of dense points respectively corresponding to the multiple second face images of the preset style, determining coordinate values of corresponding points in average dense point cloud data;
based on the coordinate values of the dense points respectively corresponding to the multiple second face images and the coordinate values of the corresponding points in the average dense point cloud data, determining coordinate difference values respectively corresponding to the multiple second face images;
based on the coordinate difference values respectively corresponding to the multiple second face images and the linear fitting coefficients, determining coordinate difference values corresponding to the first face image; and
based on the coordinate difference values corresponding to the first face image and the coordinate values of the corresponding points in the average dense point cloud data, determining the dense point cloud data of the first face image in the preset style.

15. The electronic device of claim 11, wherein the face parameter values of the face image are extracted by a neural network that is pre-trained based on sample images pre-labeled with corresponding face parameter values.

16. The electronic device of claim 15, wherein the neural network is pre-trained by:
obtaining a sample image se, wherein the sample image set comprises multiple sample images and labeled face parameter values corresponding to each of the multiple sample images;
inputting the multiple sample images into a to-be-trained neural network to obtain predicted face parameter values corresponding to each of the multiple sample images; and
based on the predicted face parameter values and the labeled face parameter values corresponding to each of the multiple sample images, adjusting network parameter values of the to-be-trained neural network to obtain a trained neural network.

17. The electronic device of claim 10, the operations further comprising:
in response to a style update triggering operation, obtaining dense point cloud data respectively corresponding to multiple second face images of a changed style;
based on the first face image and the dense point cloud data respectively corresponding to the multiple second face images of the changed style, determining dense point cloud data of the first face image in the changed style; and
based on the dense point cloud data of the first face image in the changed style, generating a virtual face model of the first face image in the changed style.

18. The electronic device of claim 10, the operations further comprising:
obtaining decoration information and skin color information corresponding to the first face image; and
based on the decoration information, the skin color information and a generated virtual face model corresponding to the first face image, generating a virtual face image corresponding to the first face image.

19. A non-transitory computer-readable storage medium storing one or more computer programs executable by at least one processor to perform operations comprising:
obtaining a first face image and dense point cloud data, the dense point cloud data respectively corresponding to multiple second face images of a preset style;
based on the first face image and the dense point cloud data respectively corresponding to the multiple second face images of the preset style, determining dense point cloud data of the first face image in the preset style; and
based on the dense point cloud data of the first face image in the preset style, generating a virtual face model of the first face image in the preset style.

20. The non-transitory computer-readable storage medium of claim 19, wherein determining the dense point cloud data of the first face image in the preset style comprises:
extracting face parameter values of the first face image and face parameter values respectively corresponding to the multiple second face images of the preset style, wherein face parameter values of a face image comprise parameter values representing a face shape in the face image and parameter values representing a face expression in the face image; and
based on the face parameter values of the first face image and the face parameter values and the dense point cloud data respectively corresponding to the multiple second face images of the preset style, determining the dense point cloud data of the first face image in the preset style.
